(19) United States
(12) Patent Application Publication
(10) Pub. No.: US 2009/0300187 A1
(43) Pub. Date: Dec. 3, 2009

(54) Transmission device having connection confirmation function

(75) Inventor: Hirotaka Yamada, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/318,432

(22) Filed: Dec. 29, 2008

(30) Foreign Application Priority Data
May 27, 2008 (JP) 2008-138436

(51) Int. Cl. G06F 15/16

(52) U.S. Cl. 709/227

(57) ABSTRACT

When establishment of a link is detected, a connection destination information request frame is transmitted via the established link to request information of a destination of connection. The connection destination information included in a connection destination information response frame received in response to that request is stored in a database and displayed on a display unit.

### CROSS-REFERENCE TO RELATED APPLICATION

This application is based upon and claims the benefit of priority of the prior Japanese Patent Application No. 2008-138436, filed on May 27, 2008, the entire contents of which are incorporated herein by reference.

### FIELD

The embodiments discussed herein are directed to a transmission device having a function of confirming a physical connection between transmission devices having pluralities of ports.

### BACKGROUND

For example, when transmission devices having large numbers of ports such as layer-2 switches (hereinafter L2SW) using an Ethernet® interface based on the IEEE 802. 1D “Media Access Control (MAC) Bridges” are connected to each other by cables or fibers, their connections can be confirmed by the naked eye when the two devices are on the same floor. In a large scale carrier network, however, the devices are separated by kilometers, therefore it cannot be confirmed by the naked eye to which ports of which transmission devices installed kilometers away cables or fibers connected to certain ports of certain transmission devices are connected. Even when this can be confirmed by the naked eye, since the number of cables or fibers is large, confirmation is difficult or it takes a long time in most cases. Further, the function of directly displaying or referring to the destinations of connections of fibers or cables does not exist in the L2SW.

For this reason, in a case of a conventional L2SW, when judging whether the destinations of connections of the fibers or cables are correct, i.e., the suitability thereof, the general practice has been to confirm this by a) connecting the fibers or cables, completing all of the VLAN or other network settings, then using the layer 3 protocol ICMP etc. to confirm that signals can pass through them end-to-end and thereby judge the suitability of the connections; b) connecting the fibers or cables, completing all of the VLAN or other network settings, then using a continuity check/loop back/link trace etc. with an EtherOAM function to judge the suitability of the connections; etc. However, there are problems that (i) in order to confirm the destination of connections of the fibers or cables, it is necessary to perform the network settings for both the devices connected from and the devices connected to; (ii) if performing the network settings for confirmation of connection while misconnected, this influences the communication of the existing network and causes the network to go down in the worst case; and (iii) even when simultaneously performing a plurality of connections, it is necessary to repeat the above procedures by a number of times equal to the number of connections. Due to this, a long time is taken, the confirmation procedures become complex, and a possibility of influencing the existing network is high.

Note that both of the following Japanese Patent No. 3958895 and Japanese Patent No. 3877557 relate to connections after the above-described network settings, that is, connections in the layer-3 (network layer) higher than the layer-2 (data link layer).

### SUMMARY

Accordingly, an object of the embodiment is to provide a transmission device able to confirm physical connections such as connections by cables or fibers laid between transmission devices having pluralities of ports.

According to an aspect of the embodiment, a transmission device having a function of confirming a “physical connection” between transmission devices having pluralities of ports is provided with a plurality of ports, a first transmitter transmitting a first connection destination information request frame requesting information of the destination of connection through a link established at one of the plurality of ports, a storage storing connection destination information included in a first connection destination information response frame received as a response with respect to the first connection destination information request frame, and an output unit outputting the stored connection destination information.

This transmission device is preferably further provided with a second transmitter transmitting a second connection destination information response frame including, as the connection destination information, data indicating the port receiving the second connection destination information request frame in response to a received second connection destination information request frame when the device receives the second connection destination information request frame requesting information of the destination of connection through the link established in one of the plurality of ports.

Note that, the “physical connection” explained before means connection by only an optical fiber, a copper wire cable, or the like. Accordingly, connection through a device having a plurality of ports and connection through a network are not included in that physical connection.

### BRIEF DESCRIPTION OF THE DRAWINGS

These and other objects and features of the embodiments will become clearer from the following description of the embodiments given with reference to the accompanying drawings, wherein:

FIG. 1 is a block diagram illustrating the configuration of an L2SW having a connection confirmation function according to an embodiment;

FIG. 2 is a diagram representing a frame format of a connection destination information request frame;

FIG. 3 is a diagram representing a frame format of a connection destination information response frame;

FIG. 4 is a first half of a flow chart depicting a first half of processing in the L2SW transmitting the connection destination information request frame;

FIG. 5 is a latter half of a flow chart depicting a latter half of the processing in the L2SW transmitting the connection destination information request frame;

FIG. 6 is a flow chart depicting processing in the L2SW receiving the connection destination information request frame;

FIG. 7 is a flow chart depicting processing at the time of a link down;

FIG. 8 is a diagram for explaining an example of connection work;

FIG. 9 is a sequence diagram depicting a flow of the processing at the time of the connection; and

FIG. 10 is a sequence diagram depicting the flow of processing at the time of a link down.

### DESCRIPTION OF EMBODIMENTS

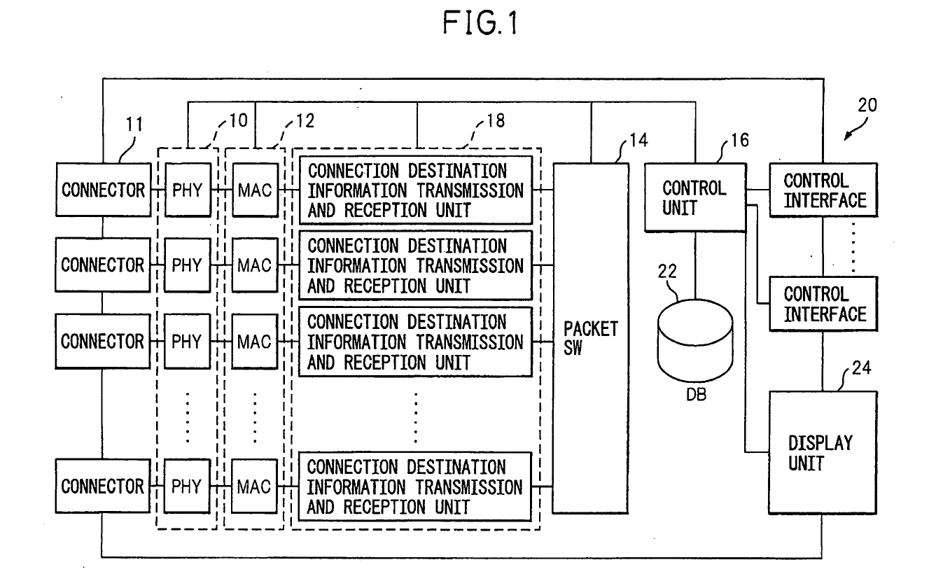

FIG. 1 illustrates an example of the configuration of a layer-2 switch (hereinafter L2SW) having a connection confirmation function, according to an embodiment. In FIG. 1, the connectors 11 act the ports for connection with the network interface of the L2SW. The shapes of the connectors differ depending on the physical interface (electric interface, optical interface, etc.). Each PHY 10 is a unit handling a layer-1 (physical layer) and sets up a link (establishes a link) of a port. It also manages the line speed and the full-duplex or half-duplex mode. The functions of the PHY's differ depending on the type of the physical interface. Each MAC 12 is a unit handling the layer-2 (data link layer) and processes a function of the link level not depending upon the physical medium.

A packet switch (SW) 14 transfers the received frame to a suitable port according to the network setting state, MAC address learning state, or the like. A control unit 16 receives a setting command etc. from a user and suitably sets the PHY's 10, MAC's 12, connection destination information transmission and reception units 18, packet SW 16, etc. Further, it has a function of storing the content thus set in a database 22, displaying the settings by a reference command from the user, displaying a warning state and statistical information of the device, or responding. A database 22 is the database storing setting information etc. of the device.

A control interface 20 is an interface for controlling and monitoring the device from a network control system or a monitor and control terminal (not illustrated). This interface is an RS-232C or other serial interface or the Ethernet® etc. The physical medium is not an issue. For the control and monitoring, there are a command line interface (hereinafter, CLI) by serial connection or network connection etc., SNMP, Syslog, etc. and a connection method equal to the existing devices is provided. A display unit 24 is an LCD or other display device displaying the state of the device. It displays a setting state of the device, information on a change of state by generation of a warning or occurrence of an event, and so on.

The packet SW 14 can set “pass” permitting the transmission and reception of a frame or set “discard” not permitting, but discarding a frame, for each port (interface) according to an instruction from the control unit 16.

Each connection destination information transmission and reception unit 18, inserted between a MAC 12 and the packet SW 14, on one hand, adds both the connection destination information request frame and the connection destination information response frame (explained later) from the control unit 16 to the flow of the frames from the packet SW 14 toward the MAC 12 and, on the other hand, picks out the connection destination information request frame and connection destination information response frame from the flow of the frames from the MAC 12 to the packet SW 14, and transfers these to the control unit 16.

Some L2SW's, for example, the Fujitsu FW5540, have registers setting a destination MAC address (DA) and EtherType. A function of extracting frames having values of DA and EtherType the same as values set in these registers and transferring the same to the control unit 16 and of adding frames from the control unit 16 to the transmission frames has already been realized by hardware. This is the function for transferring commands between L2SW; so as to confirm connection therebetween. By utilizing this function, the above connection destination information transmission and reception unit 18 can be realized. Namely, by just defining in advance unique values as the DA and EtherType of the connection destination information request frame and the connection destination information response frame and setting these unique values in a register, the above-described function can be realized.

Note that this DA does not have to be the MAC address used in an actual device, but can be set as, for example, 01:80:C2:00:00:0F. The DA can be set to, for example, 0x9876 as the EtherType. When the values of the DA or EtherType of a frame sent to the packet SW 14 from a MAC 12 through a connection destination information transmission and reception unit 18 coincide with the above exemplified values, that frame is transferred to not the packet SW 14, but the control unit 16. Further, the values of DA or EtherType of the connection destination information request and response frames, generated in the control unit 16 and further added in the connection destination information transmission and reception unit 18, are set to be the above exemplified values.

The format of the data which is written from the control unit 16 to the database 22 and read out from the same may be formed as the MIB-2 format defined by the as indicated in the following Table 1 and Table 2. Table 1 shows an example of data held in each L2SW according to the MIB-2 format. Table 2 shows an example of data held in each network interface (port).

TABLE 1

| Names | Meanings | Values (examples) |
|---|---|---|
| sysDescr | Information of entity | Fujitsu flashwave xxxx |
| | Information of System group MIB | |
| sysName | Name for management of this node | L2 switch No. 001 |
| | Information of system group MIB | |
| sysLocation | Physical position of this node | Shiodome City Center, |
| | Information of system group MIB | 1-5-2 Higashi- |
| | | Shimbashi, Minato-ku, |
| | | Tokyo 105-7123 |
| | | JAPAN |
| Connection | MAC destination address given to | 01:80:C2:00:00:0F |
| destination | frame used in connection | |
| information | destination information | |
| notification | notification function | |
| use DA | | |
| Connection | EtherType value given to frame | 0x9876 |
| destination | used in connection destination | |
| information | information notification | |
| notification | function | |
| use | | |
| EtherType | | |

TABLE 2

| Names | Meanings | Values (examples) |
|---|---|---|
| ifIndex | Information of unique values connection | 1 |
| | destination Interface group MIB from 1 to | |
| | ifNumber to which interfaces correspond | |
| ifDescr | Letter train including description concerning | Fujitsu Flashwave |
| | interface | xxxx port 1 |
| | Information of Interface group MIB | |
| Port MAC address | MAC address assigned to network Interface | 00:11:22:33:44:55 |
| Connection | State where connection destination information is | 1 |
| destination | acquired from connection destination port and | |
| information | valid. 0: invalid 1: valid | |
| validity state | | |
| Connection | sysDescr information of connection destination | Fujitsu Flashwave |
| destination | device | xxxx |
| sysDescr | | |
| Connection | sysName information of connection destination | L2 switch No. 002 |
| destination | device | |
| sysName | | |
| Connection | sysLocation information of connection destination | 1-1 Kamikodanaka |
| destination | device | 4-chome Nakahara- |
| sysLocation | | ku Kawasaki |
| | | Kanagawa 211-8588 |
| | | JAPAN |
| Connection | Connection destination ifIndex information | 3 |
| destination | | |
| ifIndex | | |
| Connection | Connection destination ifDescr information | Fujitsu Flashwave |
| destination | | xxxx port 3 |
| ifDescr | | |
| Connection | Valid/invalid setting state of connection | 1 |
| destination | destination confirmation function. 0: invalid 1: | |
| confirmation | valid. | |
| function | | |
| validity state | | |
| Connection | sysDescr value of expected connection destination | Fujitsu Flashwave |
| destination | device. Compared with sysDescr value acquired | xxxx |
| confirmation use | when connection destination confirmation function | |
| sysDescr | is valid. sysDescr value is not compared where | |
| | present database is not set (no text string). | |
| Connection | sysName value of expected connection destination | L2 switch No. 002 |
| destination | device. Compared with sysName value acquired when | |
| confirmation use | connection destination confirmation function is | |
| sysName | valid. sysName value is not compared where | |
| | present database is not set (no text string). | |
| Connection | sysLocation value of expected connection | 1-1 Kamikodanaka |
| destination | destination device. Compared with sysLocation | 4-chome Nakahara- |
| confirmation use | value acquired when connection destination | ku Kawasaki |
| sysLocation | confirmation function is valid. sysLocation value | Kanagawa 211-8588 |
| | is not compared where present database is not set | JAPAN |
| | (no text string). | |
| Connection | ifIndex value of expected connection destination | 3 |
| destination | device. Compared with ifIndex value acquired when | |
| confirmation use | connection destination confirmation function is | |
| ifIndex | valid. ifIndex value is not compared where | |
| | present database is not set (no text string). | |
| Connection | ifDescr value of expected connection destination | Fujitsu flashwave |
| destination | device. Compared with ifDescr value acquired when | xxxx port 3 |
| confirmation use | connection destination confirmation function is | |
| ifDescr | valid. ifDescr value is not compared where | |
| | present database is not set (no text string). | |

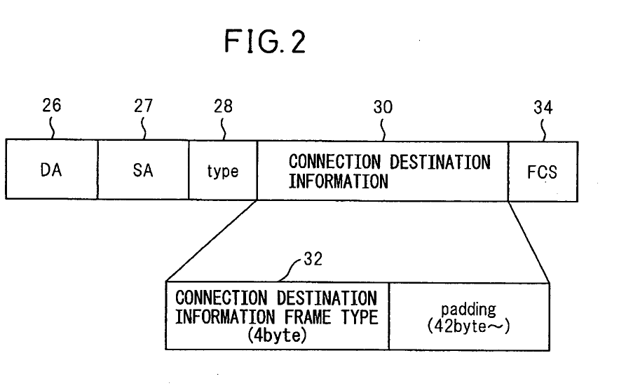

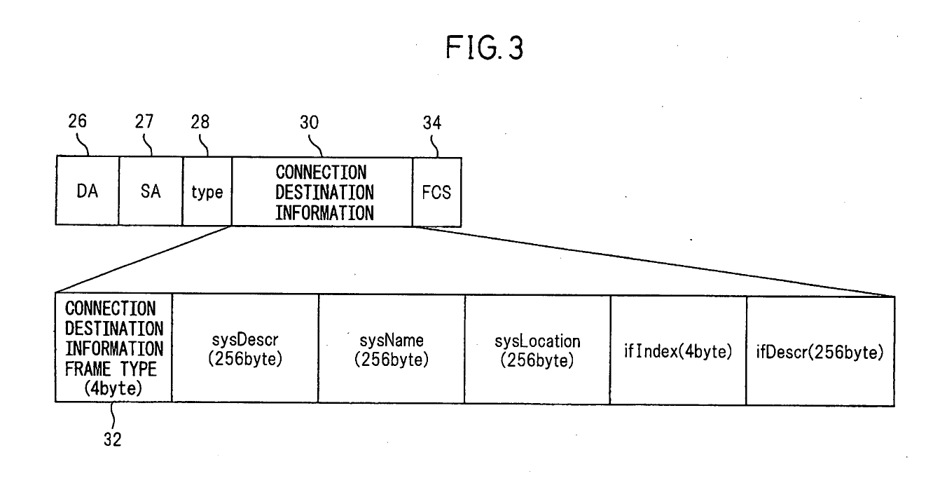

FIG. 2 and FIG. 3 illustrate examples of frame formats of a connection destination information request frame requesting information of the connection destination and a connection destination information response frame in response to the same. In FIG. 2 and FIG. 3, the DA 26 and type 28 are set with the unique values explained before. In the SA 27, a MAC address assigned to the device or port originating the frame is set. When MAC addresses are not assigned to the L2SW and ports of the L2SW, use can be made of FF:FF:FF:FF:FF:FF as the above-described value.

In for example a region 32 of the first 4 bytes of the connection destination information 30, the type of the frame is set. For example, 0x00000001 is set when the frame is a connection destination information request frame (FIG. 2), and 0x00000002 is set when the frame is a connection destination information response frame. In the case of the connection destination information response frame of FIG. 3, the connection destination information is stored in a region continuing after the connection destination information frame type 32. The values thereof are set according to the MIB-2 format and the meanings thereof are shown in Table 1 and Table 2. 0x00 is written for unused bytes.

FCS 34 is a field for detecting error of the frame and shows results of a 32-bit CRC (cyclic redundancy check) for the data from the DA 26 to just before the FCS 34. The CRC is calculated on the reception side as well. When the values of the two FCS's do not coincide, it is judged that a transmission error occurred and the frame is discarded.

The connection destination information request frame (FIG. 2) is used for inquiring about the connection destination information to the connection destination device on the occasion of the detection of a link up (link establishment) of the port or update of the connection destination information by the command from the user. In the DA 26, SA 27, and Type 28, values of the connection destination information notification use DA, port MAC address, and connection destination information notification use EtherType (see Table 1 and Table 2) are read out from the database and set.

The connection destination information frame type 32 is set to 0x00000001 (connection destination information request frame). In the padding region, no value is particularly defined. However, the padding region is for securing a region so that the length of the entire frame becomes not less than the shortest length of the MAC frame, that is, 64 bytes. In FCS 34, the results of the CRC from the DA to just before the FCS are set.

The connection destination information response frame (FIG. 3) is used for responding to the connection destination device with the connection destination information related to the receiving port at the occasion of the reception of the connection destination information request frame. In the DA 26, SA 27, and Type 28, the connection destination information notification use DA, port MAC address, and connection destination information notification use EtherType are read out from the database (see Table 1 and Table 2) and set.

The connection destination information frame type 32 is set to 0x00000002 (connection destination information response frame). For the sysDescr to ifDescr as well, the corresponding information are read out from the database and set therein. In the FCS 34, the results of the CRC from the DA to just before the FCS are set.

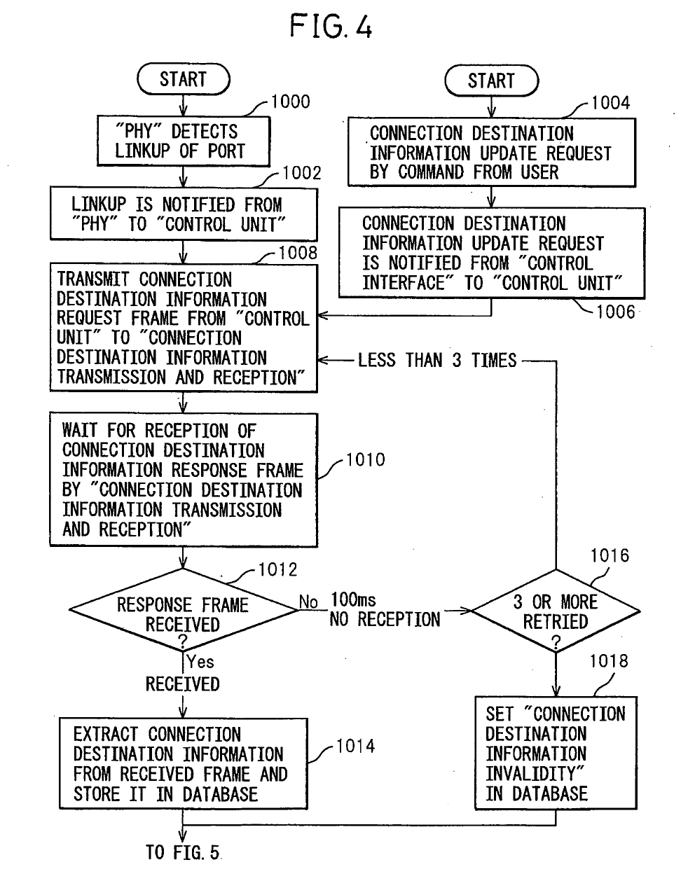

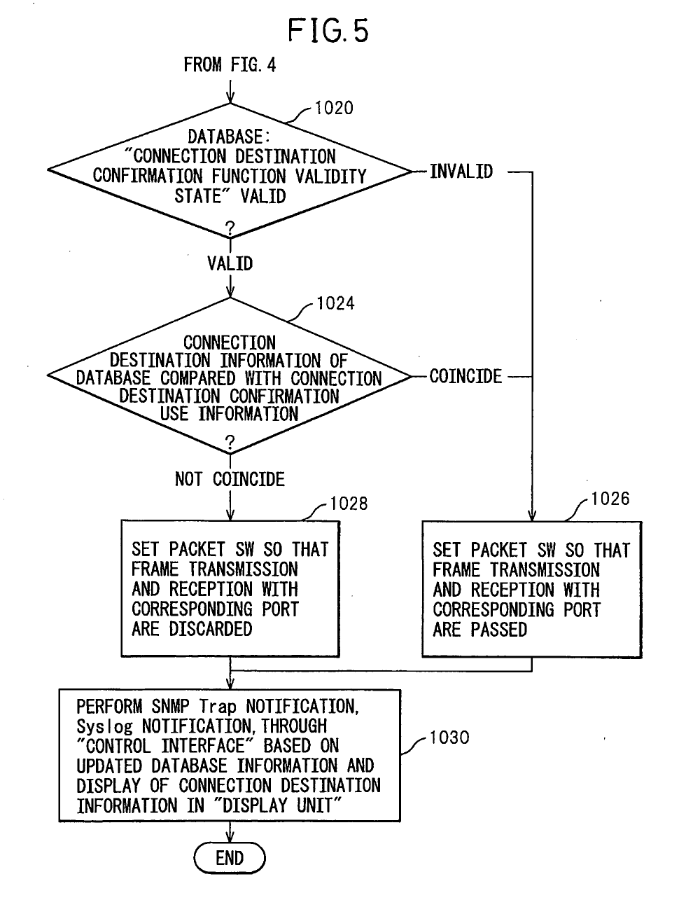

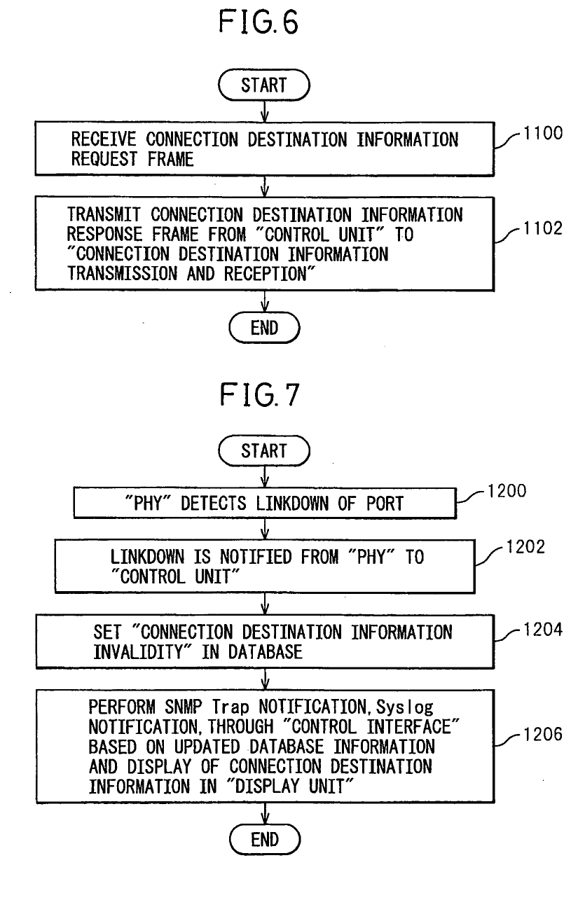

The transmission and reception processing of the connection destination information frame triggered by linkup detection of the port or a command input from the user and also both database update processing and notification processing along with the above transmission and reception processing will be explained with reference to the flow charts of FIG. 4 to FIG. 6. FIG. 4 and FIG. 5 represent processing in a L2SW transmitting the connection destination information request frame, and FIG. 6 represents the processing in a L2SW receiving the connection destination information request frame.

In FIG. 4 and FIG. 5, when any PHY 10 detects a linkup (step 1000) and when the detection is notified to the control unit 16 (step 1002) or when update of the connection destination information is requested by a command from the user (step 1004) and the request is notified via the control interface 20 (step 1006), the control unit 16 transmits the connection destination information request frame (step 1008) via the connection destination information transmission and reception unit 18 of the related port (interface).

After that, the connection destination information response frame is awaited (step 1010). When the connection destination information response frame is received (step 1012), the connection destination information is extracted from the received frame and stored in the database 22 (step 1014).

If there is no frame received for a certain period, the routine returns to step 1008 where the connection destination information request frame is retransmitted. When such retry continues three times (step 1016), the connection destination information in the database 22 is invalidated by 0x00 (step 1018).

In any case, if the “connection destination confirmation function validity state” in the database 22 (see Table 2) is “valid” (FIG. 5: step 1020), the connection destination information in the database 22, for example, “connection destination sysDescr”, “connection destination sysName”, “connection destination sysLocation”, “ifIndex”, and “ifDescr” are compared with the “connection destination confirmation use sysDescr”, “connection destination confirmation use sysName”, “connection destination confirmation use sysLocation”, “connection destination confirmation use ifIndex”, and “connection destination confirmation use ifDescr” (see Table 2). When these all coincide, the packet SW 14 is instructed so that the frames which must be transmitted and received through the related port are passed (step 1026). The same is true even when the connection destination confirmation validity state is invalid at step 1020.

When the comparison results do not coincide at step 1024, the packet SW 14 is instructed so that the frames which must be transmitted and received through the related port are discarded (step 1028). In both of the cases of steps 1026 and 1028, by performing the SNMP Trap notification and syslog notification through the control interface 20 based on the updated information of the database, these notifications are carried out to the network control system or monitor terminal, and the connection destination information is displayed in the display unit 24 of the device (step 1030).

In the L2SW at the destination of connection, as shown in the flow chart of FIG. 6, when a connection destination information request frame is received (step 1100), the connection destination information in the database 22, for example, sysDescr, sysName, sysLocation (see Table 1 for those described above), ifIndex, and ifDescr (see Table 2) are read out, and the values and information are stored in the connection destination information response frame and transmitted (step 1102).

FIG. 7 is a flow chart depicting the processing at the time of link down (disconnection of link). When any PHY 10 detects the link down (step 1200), the detection is notified to the control unit 16 (step 1202). The control unit 16 invalidates the connection destination information concerning this link stored in the database 22 (step 1204), performs the SNMP Trap notification and Syslog notification through the control interface 20 based on the updated information in the database 22, and updates the display on the display unit 24 of the device (step 1206).

The control unit 16 performing the processing described above can be realized by for example a computer and a program describing the processing thereof.

The control unit 16 of the device in FIG. 1 supports the following CLI command for an operation from the control terminal through the control interface 20. Note that the following command names are only examples. Another format etc. may be used if supporting equivalent functions.

(i) Show Interface Connection [Port Number]

It is a command for displaying to which port of which device a network port of the device is connected. To be specific, it displays sysDescr/sysName/sysLocation/ifIndex/ifDescr of the connection destination. If the port is in a link down (not connected) state, “Not connected” is displayed.

(ii) Get Interface Connection Info [Port Number]

It is a command for reacquiring the designated connection destination information. When the present command is executed, the connection destination information request frame is transmitted to the destination of the connection, and the connection destination information is reacquired. This command is used in, for example, a case where the connection destination information cannot be correctly acquired for some sort of reason.

(iii) Interface Connection Check

It is a command for registering an expected destination of connection. When the destination of connection, after linkup, differs from the expected value, the connection is judged as erroneous and a warning is notified to suspend frame transmission and reception.

Further, the control unit 16 in the device of FIG. 1 supports the following SNMP Trap and syslog notifications.

(i) Connection Notification

It is a Trap/Syslog notifying acquired connection destination information after the port acquires connection destination information by a linkup/command.

The following contents are notified.

Connection type: “Normal connection”, “erroneous connection” (when the connection destination confirmation function is valid), “unclear” (when the connection destination information cannot be acquired), and “not connected”

Information of connecting side: sysDescr/sysName/sysLocation/ifIndex/ifDescr of connecting side

Information of connected side: sysDescr/sysName/sysLocation/ifIndex/ifDescr of the destination of connection (not notified if the connection sort is unclear or not connection is not made).

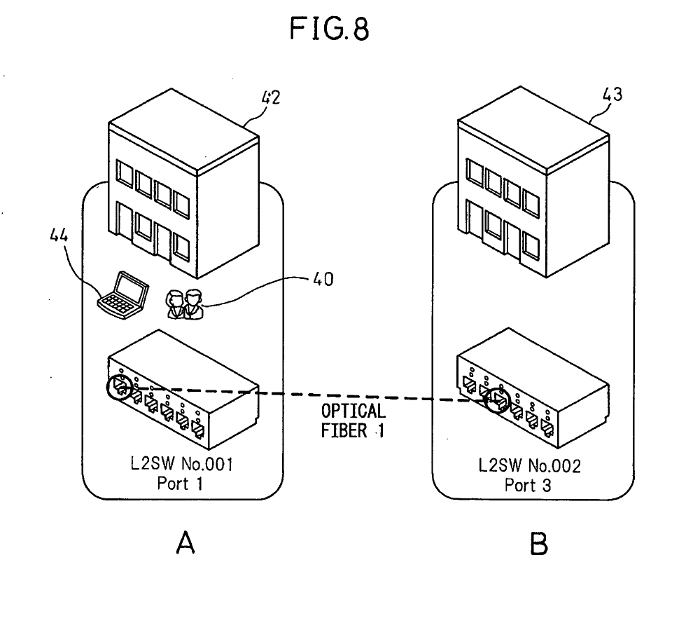

FIG. 8 illustrates a case where a Port 1 of an L2SW No. 001 existing in a building 42 at a site A and a Port 3 of an L2SW No. 002 existing in a building 43 at a site B apart from the site A by tens of kilometers are going to be connected, assuming that a fiber has already been connected to the L2SW No. 002 Port 3 at the site B and if that fiber is connected to the L2SW No. 001 Port 1 at the site A, the connection between the two will be completed and, at this time, assuming that a worker 40 enters the building 42 at the site A and performs the work of connection to the L2SW No. 001 Port 1.

First, before the start of the work, when a CLI command “show interface connection” is input from a control terminal 44 to confirm the port connection state of the L2SW No. 001 in the not connected state, the display as shown in the following Table 3 is performed in the terminal 44. The Port 1 is not connected, therefore “Not connected” is displayed. The following case is the example of the display by a CLI command, but equivalent information is displayed on the side of the display unit 24 (FIG. 1) as well.

TABLE 3
# show interface connection
[Interface Connection]

| Source Port | Destination Port |
|---|---|
| Port 1 | Not connected |
| Port 2 | Not connected |
| . | . |
| . | . |
| . | . |
| Port 6 | Not connected |

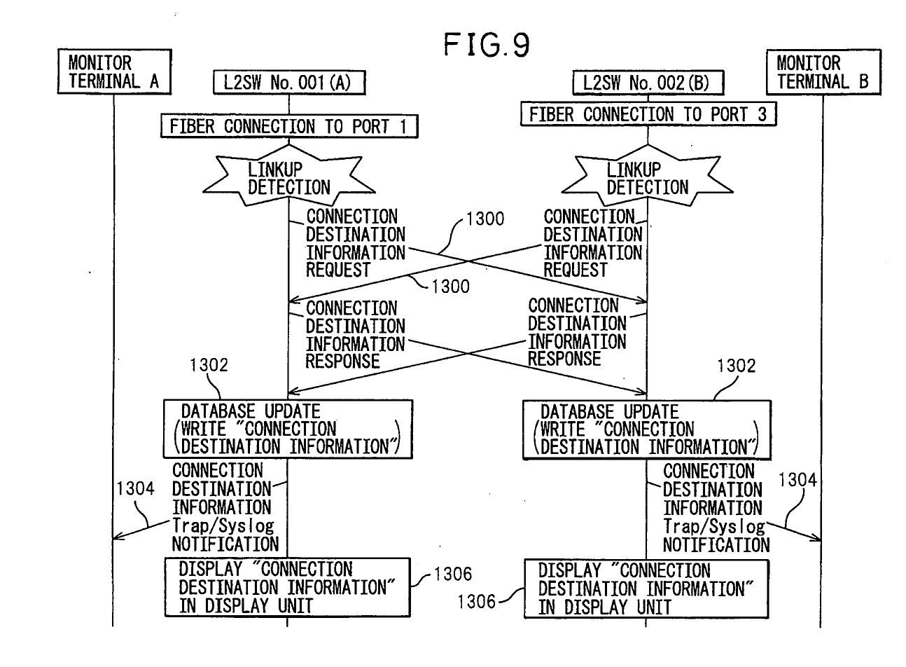

Next, the worker 40 connects the above-described fiber to the L2SW No. 001 Port 1. The ports (1, 3) of the devices (A, B) link up and exchange connection destination information with each other. The flow of detailed processing at this time will be shown in FIG. 9. In FIG. 9, the connection destination information are exchanged (step 1300), the database is updated (step 1302), the user is notified of the updated information (step 1304), and the display unit 24 displays the information (step 1306). After that, when confirming connection by the CLI command “show interface connection”, information is displayed as shown in the following Table 4.

TABLE 4
# show interface connection
[Interface Connection]

| Source Port | Destination Port |
|---|---|
| Port 1 | Connection OK. |
| | System: Fujitsu flashwave xxxx |
| | Name: L2 switch No. 002 |
| | Location: B |
| | ifIndex: 3 |
| | ifDescr: Fujitsu flashwave xxxx port 3 |
| Port 2 | Not Connected |
| . | . |
| . | . |
| . | . |
| Port 6 | Not Connected |

The above-described connection has been normally carried out, therefore “Connection OK” is displayed. This “Connection OK” is displayed at (i) the time when linkup occurs in the state where the connection destination confirmation function is invalid or at (ii) the time when the acquired connection destination confirmation and the destination of connection registered by the command coincide in the state where the connection destination confirmation function is valid. The other displayed System/Name/Location/ifIndex/ifDescr of Table 4 described above are the connection destination sysDescr/connection destination sysName/connection destination sysLocation/connection destination ifIndex/connection destination ifDescr which are acquired and stored in the database.

Next, an example of a case where the worker 40 erroneously connects the L2SW No. 002 Port 6 to the L2SW No. 001 Port 1 will be shown. Note that, assume here that, before the connection, the “connection destination confirmation function” is validated, and the L2SW No. 002 Port 3 is registered as the expected connection destination. The processing sequence is the same as the flow of the processing when performing a correct connection (FIG. 9). After that, when confirmation by the CLI command “show interface connection” is carried out, information is displayed as shown in the following Table 5. In this case, because of the erroneous connection, “Connection NG” is displayed. The other displayed System/Name/Location/ifIndex/ifDescr of Table 5 are information of the erroneous destination of connection, therefore it can be instantaneously confirmed to which device or port it is erroneously connected. Further, in this state, the L2SW No. 001 Port 1 and the L2SW No. 002 Port 6 have been erroneously connected. Therefore, for the transmission and reception of frames, frame discard is set. Accordingly, the inflow of frames to an erroneous network, looping and proliferation of frames, and other matters exerting an influence upon existing networks are prevented.

TABLE 5
# show interface connection
[Interface Connection]

| Source Port | Destination Port |
|---|---|
| Port 1 | Connection NG. |
| | System: Fujitsu flashwave xxxx |
| | Name: L2 switch No. 002 |
| | Location: B |
| | ifIndex: 6 |
| | ifDescr: Fujitsu flashwave xxxx port 6 |
| Port 2 | Not Connected |
| . | . |
| . | . |
| . | . |
| Port 6 | Not Connected |

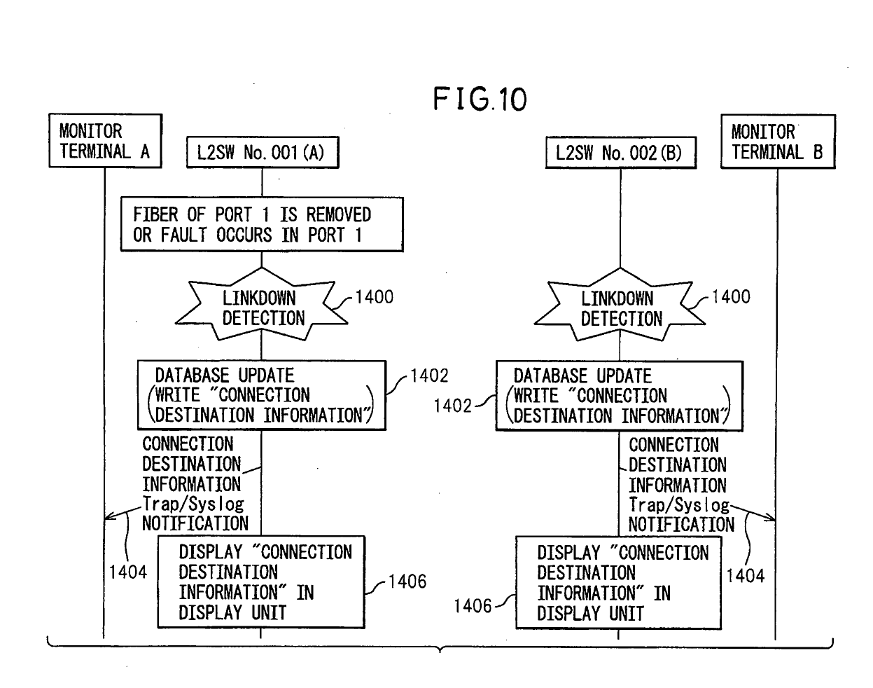

Further, the flow of the processing in a case where a linkdown occurs due to occurrence of a fault, pullout of the fiber, etc. will be shown in FIG. 10. In the case of linkdown detection, since the two devices (A, B) cannot communicate therebetween, the devices (A and B) are triggered by the linkdown detection (both steps 1400) and perform database update processing (both steps 1402), user notification processing(both steps 1404), and display the information on the display unit 24 (both steps 1406).

According to the device disclosed in the present specification, when devices for which destinations of connection cannot be viewed are connected to each other, confirmation of the connection becomes easy and erroneous connection of the fibers or cables is prevented. Even within a range where the device connected to can be seen by the naked eye, in a case connecting a plurality of fibers or cables, destinations of connection of fibers or cables can be easily confirmed by using the command etc. from the monitor device, therefore network maintenance becomes easy. Further, by validating the connection destination confirmation function and registering the expected connection destination in advance, automatic notification of erroneous connection and suspension of frame transmission and reception become possible. Accordingly, an erroneous connection can be coped with in an early stage, and the influence upon the existing network can be suppressed to the minimum.

What is claimed is:

1. A transmission device having a function of confirming a physical connection between transmission devices provided with pluralities of ports, comprising:
a plurality of ports;
a first transmitter transmitting a first connection destination information request frame requesting information of a destination of connection via a link established in one of the plurality of ports;
a storage storing connection destination information included in a first connection destination information response frame received in response to the first connection destination information request frame; and
a first output unit outputting the stored connection destination information.

2. The transmission device as set forth in claim 1, further comprising a second transmitter transmitting a second connection destination information response frame including data, as connection destination information, indicating a port receiving the second connection destination information request frame in response to a received second connection destination information request frame when the device receives a second connection destination information request frame requesting the information of the destination of connection via a link established in one of the plurality of ports.

3. The transmission device as set forth in claim 1, further comprising:
a judging unit judging whether or not the stored connection destination information indicates a correct connection destination and
a second output unit outputting that judgment result.

4. The transmission device as set forth in claim 3, further comprising a discard unit discarding a frame transmitted and received via the one port when it is judged that the connection destination information indicates an incorrect connection destination.

5. The transmission device as set forth in claim 1, further comprising:
a switch controlling routing of the frame according to the destination of the frame and
a transmitting and receiving unit, on one hand, adding the connection destination information request frame to the flow of the frame from the switch and, on the other hand, picking out the first destination information response frame from the flow of the frame to the switch.
